(19) United States
(12) Patent Application Publication
(10) Pub. No.: US 2019/0383409 A1
(43) Pub. Date: Dec. 19, 2019

(54) SLAM-SHUT SAFETY DEVICE FOR USE IN DIRTY SERVICE APPLICATIONS

(71) Applicant: Emerson Process Management Regulator Technologies, Inc., McKinney, TX (US)

(72) Inventors: Madhusudhan Reddy Kotragouda Basappa, Frisco, TX (US); Nathan E. Wilhelm, Dallas, TX (US); Justin W. Hart, Melissa, TX (US)

(21) Appl. No.: 16/012,148

(22) Filed: Jun. 19, 2018

(51) Int. Cl. F16K 17/168; F16K 17/32; F17D 1/04; F17D 5/00

(52) U.S. Cl. CPC F16K 17/168; F17D 5/005; F17D 1/04; F16K 17/32

(57) ABSTRACT

A slam-shut safety device including a valve body defining a flow path extending between an inlet and an outlet, a bonnet including a sleeve extending into the flow path and having one or more flow ports, an actuator arranged to detect an overpressure or underpressure condition, a control element movable between an open first position and a closed second position, a reset pin operatively coupled to the control element and movable between an un-tripped position, placing the control element in the open first position, and a tripped position, placing the control element in the closed second position, the reset pin configured to move from the un-tripped position toward the tripped position responsive to the actuator detecting the overpressure or underpressure condition, and a seal arranged to substantially prevent accumulation of particulates carried by fluid flowing through the one or more flow parts on the outer surface of the control element.

### FIELD OF THE DISCLOSURE

The present disclosure generally relates to slam-shut safety devices and, more particularly, to a slam-shut safety device for use in dirty service applications.

### BACKGROUND

Gas distribution systems, such as systems used to distribute natural gas, typically transport gas from a producer to a consumer along a series of pipes and through a series of valves. Each gas distribution system may include one or more regulator valves that control the pressure of the gas within the distribution system. Normally, the gas is transmitted at a high pressure through the system. However, the pressure of the gas must be reduced prior to final distribution to the consumers. This pressure reduction is typically accomplished at pressure reducing stations within local networks.

Typically, these pressure reducing stations include one or more pressure regulating valves and some sort of safety device to shut off the flow of gas should the pressure regulating valve fail. Most commonly, slam-shut safety valves are used for this purpose. For example, U.S. Pat. No. 4,134,421 discloses a slam-shut safety valve that provides overpressure protection in a pipeline. Another example of a slam-shut safety valve is disclosed in U.S. Pat. No. 8,225,812. The slam-shut safety valve is generally disposed upstream of the pressure regulating valve so that the slam-shut valve may prevent gas from reaching the pressure regulating valve in the event of the pressure regulating valve has failed. The slam-shut safety valve monitors gas pressure downstream of the pressure regulating valve for maximum and minimum pressure tolerances. If the downstream pressure exceeds either the maximum or minimum tolerance, the slam-shut safety valve closes, cutting off the flow of gas to the pressure regulating valve and preventing an uncontrolled leak of gas due to the pressure regulating valve failure.

### SUMMARY

One aspect of the present disclosure includes an assembly for a slam-shut safety device. The assembly includes a valve body having an inlet, an outlet, and defining a flow path extending between the inlet and the outlet, the valve body including a slam-shut valve seat defining an orifice that forms part of the flow path between the inlet and the outlet. The assembly includes a bonnet coupled to the valve body and including a sleeve extending into the flow path including one or more flow ports. The assembly includes a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice. The assembly also includes a reset pin operatively coupled to the control element and movable along the slam-shut axis relative to the valve body between an un-tripped position, placing the control element in the open first position, and a tripped position, placing the control element in the closed second position, the reset pin adapted to move from the un-tripped position toward the tripped position responsive to an overpressure condition or an underpressure condition. The assembly further includes a seal arranged to direct fluid flowing through the one or more flow ports of the sleeve away from an outer surface of the control element, thereby substantially preventing accumulation of particulates carried by the fluid on the outer surface of the control element.

Another aspect of the present disclosure includes an assembly for a slam-shut safety device. The assembly includes a valve body having an inlet, an outlet, and defining a flow path extending between the inlet and the outlet, the valve body including a slam-shut valve seat defining an orifice that forms part of the flow path between the inlet and the outlet. The assembly includes a bonnet coupled to the valve body and including a sleeve extending into the flow path including one or more flow ports. The assembly includes a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice. The assembly also includes a reset pin operatively coupled to the control element and movable along the slam-shut axis relative to the valve body between an un-tripped position, placing the control element in the open first position, and a tripped position, placing the control element in the closed second position, the reset pin adapted to move from the un-tripped position toward the tripped position responsive to an overpressure condition or an underpressure condition. The assembly further includes a seal assembly arranged in a gland formed in the sleeve or the control element to direct fluid flowing through the one or more flow ports of the sleeve away from an outer surface of the control element, thereby substantially preventing accumulation of particulates carried by the fluid on the outer surface of the control element.

Another aspect of the present disclosure includes a slam-shut safety device. The slam-shut safety device includes a valve body having an inlet, an outlet, and defining a flow path extending between the inlet and the outlet, the valve body including a slam-shut valve seat defining an orifice that forms part of the flow path between the inlet and the outlet. The slam-shut safety device includes a bonnet coupled to the valve body and including a sleeve extending into the flow path including one or more flow ports. The slam-shut safety device includes an actuator coupled to the bonnet and arranged to detect an overpressure condition or an underpressure condition. The slam-shut safety device includes a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice. The slam-shut safety device also includes a reset pin operatively coupled to the control element and movable along the slam-shut axis relative to the valve body between an un-tripped position, placing the control element in the open first position, and a tripped position, placing the control element in the closed second position, the reset pin adapted to move from the un-tripped position toward the tripped position responsive to the actuator detecting the overpressure condition or an underpressure condition. The slam-shut safety device further includes a seal arranged to direct fluid flowing through the one or more flow ports of the sleeve away from an outer surface of the control element, thereby substantially preventing accumulation of particulates carried by the fluid on the outer surface of the control element.

Any of the above aspects of the disclosure may include any one or more of the following preferred forms.

In one preferred form, the seal includes at least one of an o-ring and a piston ring.

In another preferred form, the assembly includes a valve stem, the reset pin being operatively coupled to the control element via the valve stem.

In another preferred form, the assembly includes a biasing element arranged to bias the control element toward the closed second position. The biasing element may have a first end seated against the bonnet and a second end seated against the control element. The biasing element may be at least partially disposed within the control element.

In another preferred form, the seal prevents fluid from flowing between the sleeve and the control element.

In another preferred form, the gland is formed in an outer surface of the control element.

In another preferred form, the seal is arranged in a gland formed in the sleeve or the control element.

In another preferred form, the actuator comprises a relay mechanism, wherein the relay mechanism has a first position in which the relay mechanism retains the reset pin in the un-tripped position, and wherein responsive to the actuator detecting the overpressure condition or the underpressure condition, the relay mechanism moves from the first position to a second position in which the relay mechanism allows the reset pin to move from the un-tripped position to the tripped position.

In another preferred form, the actuator further includes a diaphragm operatively coupled to the relay mechanism via a control rod, wherein the diaphragm moves responsive to the overpressure condition or the underpressure condition, and wherein movement of the diaphragm causes the relay mechanism to move from the first position to the second position.

Additional optional aspects, arrangements, examples, and features are disclosed, which may be arranged in any functionally appropriate manner, either alone or in any functionally viable combination, consistent with the teachings of the disclosure. Other aspects and advantages will become apparent upon consideration of the following detailed description.

### BRIEF DESCRIPTION OF THE DRAWINGS

FIG. 1 is a perspective view of a slam-shut safety device constructed in accordance with teachings of the present disclosure.

FIG. 2 is a cross-sectional view of the slam-shut safety device of FIG. 1, showing the slam-shut safety device in an open position.

FIG. 3 is a close-up view of a portion of FIG. 2, showing a control element, a sleeve, and a seal assembly arranged between the control element and the sleeve to direct fluid flow away from an outer surface of the control element.

FIG. 3A is a close-up view of the seal assembly of FIG. 3.

FIG. 4 is a partial cross-sectional view of an actuator of the slam-shut safety device of FIG. 1.

FIG. 5 is a perspective view of a relay mechanism of the actuator of FIG. 4.

FIG. 6 is similar to FIG. 1, but shows the slam-shut safety device in a closed position.

### DETAILED DESCRIPTION

When known slam-shut safety devices such as those described above are used in dirty service applications (i.e., applications involving severe flow conditions, e.g., catalyst fines in refineries, magnetite in power plants, sand in oil production), the fluid (e.g., gas) flowing therethrough attracts and carries particulates (e.g., debris). Over time, the particulates carried by the fluid damage the control element (e.g., a valve plug) and tend to accumulate on an outer surface of the control element. This accumulation eventually interferes with the movability of that control element, often in a manner that prevents the control element from reaching its closed position to provide safety shutoff when desired.

The present disclosure is thus directed to a slam-shut safety device that is configured to provide a safety shutoff capability and can be used in dirty service applications (as well as clean applications) without negatively affecting the safety shutoff capability of the slam-shut safety device. More particularly, the slam-shut safety device has a valve body and a control assembly that selectively provides safety shutoff, when desired, but is constructed in a manner that prevents particulates carried by the fluid flowing therethrough from damaging the control element or accumulating on an outer surface of the control element when the slam-shut safety device is used in dirty service applications.

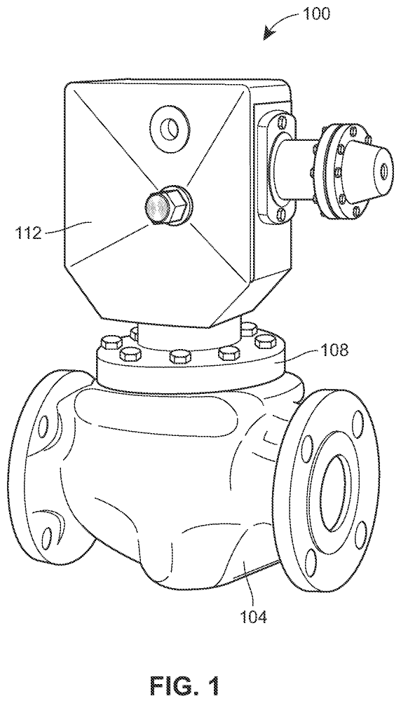

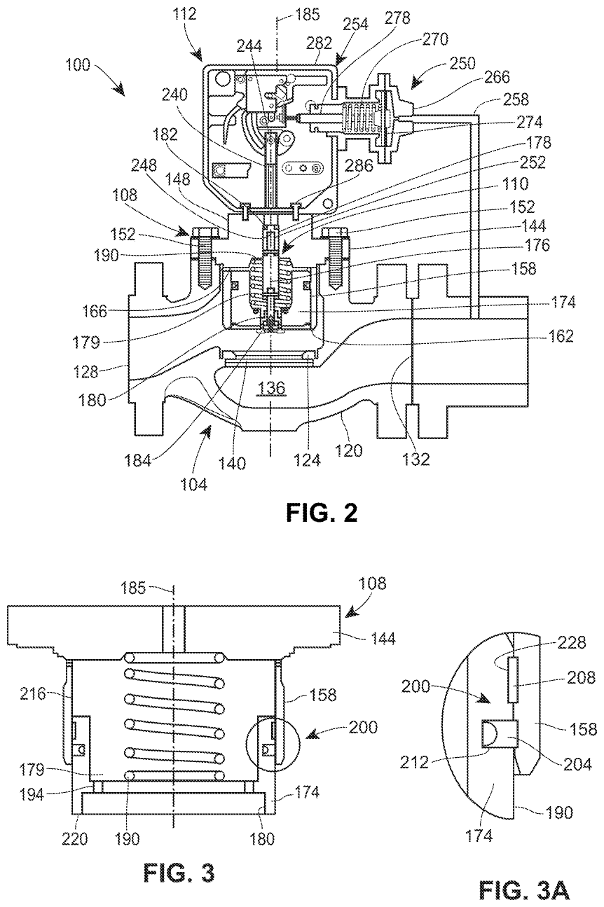

FIGS. 1-6 illustrate one example a slam-shut safety device 100 constructed in accordance with the teachings of the present disclosure. As discussed above, the slam-shut safety device 100 is configured for attachment to a main regulator in a gas distribution system (partially depicted in FIG. 2) to provide a safety shutoff capability in the event the main regulator fails, regardless of whether the slam-shut safety device 100 is used in clean or dirty service applications. The slam-shut safety device 100 in this example generally includes a valve portion 104, a bonnet 108 coupled to the valve portion 104, a control assembly 110, and an actuator 112 operatively coupled to the valve portion 104 via the bonnet 108. However, in other examples, the slam-shut safety device 100 can include more, less, or different components. As an example, the slam-shut safety device 100 may include a different valve portion 104 or a different actuator 112 (or no actuator 112 at all).

Referring to FIGS. 1 and 2, the valve portion 104 includes a valve body 120 and a slam-shut valve seat 124. The valve body 120 has a fluid inlet 128 and a fluid outlet 132 connected by a fluid passage forming a flow path 136. The slam-shut valve seat 124 is disposed within the valve body 120 and defines a flow orifice 140 that forms a portion of the flow path 136. The slam-shut valve seat 124 may be removably or fixedly disposed in position within the valve body 120. In any event, it will be appreciated that fluid flowing through the valve portion 104 flows from the fluid inlet 128 to the fluid outlet 132 via or through the flow path 136 (including the flow orifice 140).

Referring still to FIGS. 1 and 2, the bonnet 108 in this example has a flanged portion 144 and a neck portion 148 that extends outward (upward, in FIG. 2) from the flanged portion 144. In this example, the bonnet 108 is coupled to the valve portion 104 by securing the flanged portion 144 to the valve body 120 via a plurality of fasteners 152. In other examples, however, the bonnet 108 can be coupled to the valve portion 104 in a different manner.

As best illustrated in FIG. 2, the bonnet 108 in this example also includes a sleeve 158 that is coupled to (e.g., integrally formed with) and extends outward (downward, in FIG. 2) from the flanged portion 144. Thus, the sleeve 158 extends into the valve body 120 and into the flow path 136, such that an end 162 of the sleeve 158 is positioned proximate to but spaced from the valve seat 124. As also illustrated in FIG. 2, the bonnet 108 in this example includes one or more flow ports 166 formed in the sleeve 158 at a position immediately adjacent the flanged portion 144. It will be appreciated that some of the fluid flowing through the flow path 136 will flow through the flow ports 166 as the fluid flows from the fluid inlet 128 to the fluid orifice 140. Finally, while not illustrated herein, the bonnet 108 can, as is known in the art, include valve packing, one or more packing rings, and one or more packing flanges.

Referring to FIGS. 2 and 3, the control assembly 110 includes a control element 174 and a valve stem 176 coupled to the control element 174 in any known manner. The control element 174 is generally movably disposed within the sleeve 158 (i.e., the sleeve 158 at least partially surrounds the control element 174). In this example, the control element 174 takes the form of a valve plug, though the control element 174 may instead take the form of a valve disc or other control element. The valve stem 176 partially extends through a bore 178 formed in the bonnet 108 and extends through first and second bores 179, 180 each formed in the control element 174, such that the valve stem 176 has a first end 182 disposed in the bonnet 108 and a second end 184, opposite the first end 182, that is disposed within the valve body 120 and engages a bottom portion of the control element 174. Accordingly, the second end 184 of the valve stem 176 carries the control element 174 such that the control element 174 and the valve stem 176 move in unison with one another.

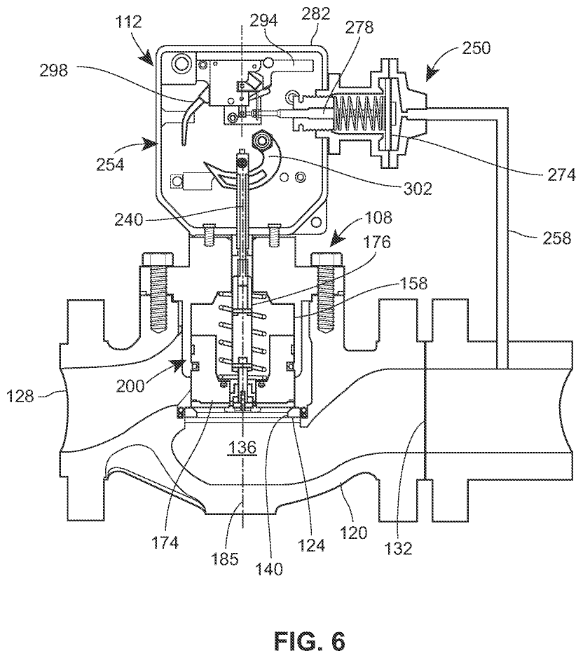

Thus, when the slam-shut safety device 100 is in operation, the control element 174 and the valve stem 176 are movable relative to the slam-shut valve seat 124 and the sleeve 158 to control fluid flow through the valve body 120. More particularly, the control element 174 and the valve stem 176 are movable within the valve body 120, along a slam-shut axis 185, between a first position, shown in FIG. 2, and a second position, shown in FIG. 6 (and partially shown in FIG. 3). In the first position, the control element 174 is spaced from the slam-shut valve seat 124, thereby opening the fluid orifice 140 and allowing fluid flow between the fluid inlet 128 and the fluid outlet 132. In the second position, the control element 174 is positioned in sealing engagement with the slam-shut valve seat 124, thereby closing the fluid orifice 140 and preventing fluid flow between the fluid inlet 128 and the fluid outlet 132.

The control assembly 110 also includes a biasing element 190. The biasing element 190, which in this example takes the form of a spring, is positioned to apply a biasing force to the control element 174 in order to urge the control element 174 and the valve stem 176 toward the second, closed position. In this example, the biasing element 190 is partially disposed within the first bore 179 of the control element 174 and has one end that bears against a portion of the bonnet 108 (particularly the flanged portion 144 of the bonnet 108) and another end that bears against a shoulder surface 194 of the control element 174 that separates the first and second bores 179, 180 of the control element 174. In other examples, however, the biasing element 190 can be arranged in a different manner. As an example, the biasing element 190 can be seated against an outer surface 198 of the control element 174 instead of against the shoulder surface 190 within the control element 174.

The control assembly 110 also includes a seal assembly 200 that is arranged to effectuate a seal between the sleeve 158 and the control element 174. As illustrated in FIG. 3A, the seal assembly 200 in this example includes a first seal 204 and a second seal 208 each arranged in the outer surface 190 of the control element 174. The first seal 204 preferably takes the form of an energized o-ring that is made of an elastomeric material and arranged in a gland 212 formed in the outer surface 190 of the control element 174 between first and second ends 216, 220 of the control element 174. Thus, the first seal 204 has an inner surface that engages an interior surface of the control element 174, and an outer surface that is radially outward of the outer surface 190 and sealingly engages an inner surface 224 of the sleeve 158, but does so with minimal friction. The second seal 208, meanwhile, preferably takes the form of a piston ring that is made of a low-friction material (e.g., PTFE) and arranged in a gland 228 formed in the outer surface 190 of the control element 174 between the first end 216 and the first seal 204. Thus, like the first seal 204, the second seal 208 has an inner surface that engages an interior surface of the control element 174, and an outer surface that is radially outward of the outer surface 190 and sealingly engages the inner surface 224 of the sleeve 158 (again, with minimal friction). In other examples, however, the seal assembly 200 may only include one seal (e.g., the first seal 204, the second seal 208, a different seal), one or more different seals, and/or differently arranged seals. As an example, one or more of the seals of the seal assembly 200 can be arranged in a gland formed in an inner surface of the sleeve 158. Moreover, in other examples, the first seal 204 and/or the second seal 208 can be made of one or more different materials.

By effectuating a seal between the sleeve 158 and the control element 174, the seal assembly 200 substantially prevents fluid flowing through the one or more flow ports 166 of the sleeve 158 from flowing between the outer surface 190 of the control element 174 and the inner surface 224 of the sleeve 158. In other words, the seal assembly 200 substantially directs fluid flowing through the one or more flow ports 166 of the sleeve 158 away from the outer surface 198 of the control element 174. Accordingly, the seal assembly 200 reduces, if not totally prevents, particulates carried by the fluid flowing through the one or more flow ports 166 from contacting, much less accumulating on, the outer surface 190.

As best illustrated in FIGS. 2, 4, 5, and 6, the control assembly 110 further includes a reset pin 240 that is operatively coupled to the control element 174 via the valve stem 176. More particularly, the reset pin 240 has a first end 244 that is disposed in the actuator 112 and a second end 248, opposite the first end 244, that is coupled to the valve stem 176. In this example, the second end 248 of the reset pin 240 is securely disposed within an aperture 252 formed in the valve stem 176. In other examples, however, the second end 248 may be coupled to the valve stem 176 in another known manner. In any case, the reset pin 240 moves together with the control element 174 and the valve stem 176 along the slam-shut axis 185, relative to the valve body 120 and the sleeve 158, between a retracted or un-tripped position, also shown in FIG. 2, in which the control element 174 is in its first position (spaced from the slam-shut valve seat 124), and an extended or tripped position, also shown in FIG. 6, in which the control element 174 is in its second position (seated against the slam-shut valve seat 124).

With reference still to FIGS. 2, 4, 5, and 6, the actuator 112 in this example is a release relay type actuator manufactured by, for example, Emerson Process Management. The release relay type actuator 112 includes a manometric box 250 and a mechanism box 254 that receives the manometric box 250 and is coupled to the bonnet 108. The manometric box 250 is generally configured to detect pressure changes at a position downstream of the slam-shut safety device 100 (e.g., via pressure feedback line 258) and communicate those pressure changes to the mechanism box 254, which has a relay mechanism 262 that selectively responds to those pressure changes.

As best illustrated in FIGS. 2 and 6, the manometric box 250 includes a housing 266 that encloses a spring 270 connected to a diaphragm 274. The diaphragm 274 is sensitive to pressure changes communicated via the pressure feedback line 258, such that the diaphragm 274 can, via the pressure feedback line 258, detect an overpressure condition (which occurs when the downstream pressure exceeds a pre-determined maximum pressure) or an underpressure condition (which occurs when the downstream pressure is less than a pre-determined minimum pressure), each of which may indicate that the main regulator has failed. The diaphragm 274 generally moves within the housing 266 (right or leftward in FIG. 2) in response to those pressure changes. The manometric box 250 also includes a control rod 278 that is connected to the diaphragm 274 and moves within the housing 266 in conjunction with the diaphragm 274. Movement of the control rod 278 in this manner generally causes the relay mechanism 262 to move between a first position, in which the relay mechanism 262 securely retains the reset pin 240 in the un-tripped position, and a second position, in which the reset pin 240 is released and allowed to move from its un-tripped position to its tripped position.

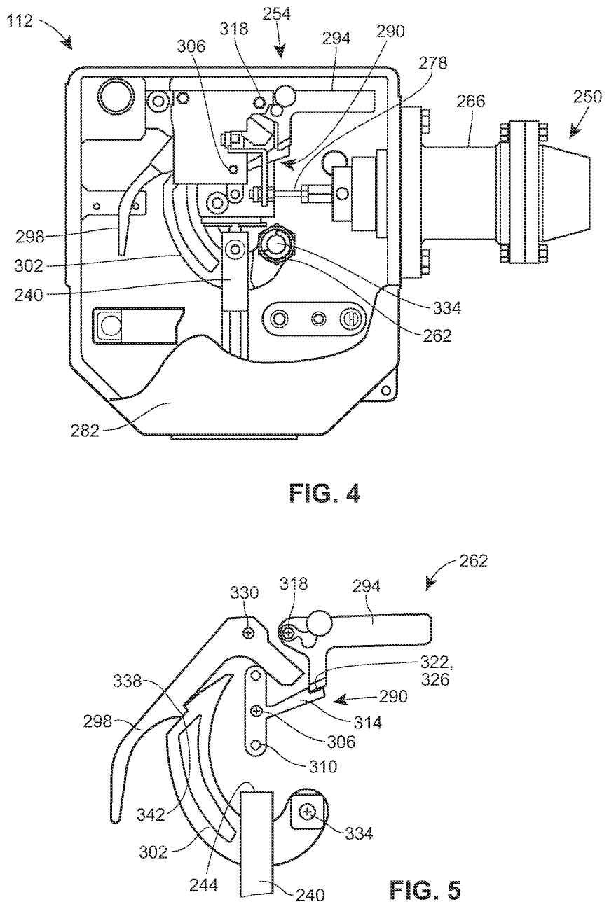

Meanwhile, as best illustrated in FIG. 4, the mechanism box 254 includes a housing 282 and the relay mechanism 262, which is arranged in the housing 282. In this example, the mechanism box 254 is coupled to the bonnet 108 by securing the housing 282 to the neck 148 of the bonnet 108 via a plurality of fasteners 286. In other examples, however, the mechanism box 254 can be coupled to the bonnet 108 in a different known manner.

As best illustrated in FIGS. 4 and 5, the relay mechanism 262 in this example includes a releasing stem 290, a first trigger 294, a second trigger 298, and a cam 302. The releasing stem 290 is pivotably coupled to a portion of the housing 282 via a pivot axis 306 that is perpendicular to the slam-shut axis 185. The releasing stem 290 includes a base 310 and an arm 314 that extends outward from the base 310. The first trigger 294 is also pivotably coupled to the housing 282 via a pivot axis 318 that is parallel to the pivot axis 306. The first trigger 294 has a projection 322 that selectively engages a notch 326 formed in the arm 314 of the releasing stem 290 to selectively retain the first trigger 294 in the position shown in FIG. 5 and prevent the first trigger 294 from rotating relative to the releasing stem 290 (and vice-versa). The second trigger 298 and the cam 302 are likewise pivotably coupled to the housing 282 via pivot axes 330, 334, respectively, that are parallel to one another and the pivot axes 306, 318. The second trigger 298 has a projection 338 that is similar to the projection 322 but selectively engages a notch 342 formed in the cam 302 to selectively retain the cam 302 in the position shown in FIG. 5 and prevent the cam 302 from rotating relative to the second trigger 298 (and vice-versa).

In other examples, however, the actuator 112 may vary. In some examples, the actuator 112 may instead take the form of a different type of pneumatic actuator or a completely different type of actuator, e.g., a hydraulic actuator, an electric actuator, or a manual actuator. In some examples, the relay mechanism 262 may include differently shaped, sized, and/or arranged components.

In operation, when the diaphragm 274 detects an overpressure condition or an underpressure condition via the feedback line 258, the slam-shut safety device 100 will close, thereby providing shutoff, as illustrated in FIG. 6. More particularly, when the diaphragm 274 detects an overpressure condition, the diaphragm 274 moves (to the left in FIG. 2), which thus causes the control rod 278 connected to the diaphragm 274 to move (to the left as well). The control rod 278 moves toward and into engagement with the base 310 of the releasing stem 290, which causes the releasing stem 290 to rotate (in a clockwise direction in FIGS. 2, 4, and 5) about the pivot axis 306. As the releasing stem 290 rotates, the projection 322 of the first trigger 294 is disengaged from the notch 326 formed in the arm 314 of the releasing stem 290, thereby releasing the first trigger 294 from the position shown in FIGS. 2 and 5 and allowing the first trigger 294 to rotate (in a counterclockwise direction in FIGS. 2, 4, and 5) about the pivot axis 318. Rotation of the first trigger 294 causes the first trigger 294 to engage the second trigger 298, which drives the projection 338 of the second trigger 298 out of engagement with the notch 342 of the cam 302, thereby releasing the cam 302 from the position shown in FIG. 5 and allowing the cam 302 to rotate (in a counterclockwise direction in FIGS. 2, 4, and 5). Rotation of the cam 302 in this manner allows the reset pin 240, which is coupled to and carried by the cam 302, to move (e.g., fall) from its un-tripped position to its tripped position. It will be appreciated that in this example that once the cam 302 is released, the reset pin 240 automatically moves from its un-tripped position to its tripped position as a result of gravity. In any case, as the reset pin 240 moves from its un-tripped position to its tripped position, the control element 174 moves, along the slam-shut axis 185, toward and into contact with the slam-shut valve seat 124, thereby closing the flow orifice 140 and shutting off fluid flow through the flow path 136 in the valve body 120.

Conversely, when the diaphragm 274 detects an underpressure condition via the feedback line 258, the diaphragm 274 moves (to the right in FIG. 2), which thus causes the control rod 278 connected to the diaphragm 278 to move (to the right as well). As the control rod 278 moves in this manner, a hook element (see FIG. 4) that operatively connects the control rod 278 to the releasing stem 290 applies a force (rightward, in FIG. 2) on a top portion of the base 310 of the releasing stem 290, which causes the releasing stem 290 to rotate (in a clockwise direction in FIGS. 2, 4, and 5) about the pivot axis 306. In turn, the first trigger 294, the second trigger 298, and the cam 302 move in the exact manner as described above in connection with the detection of the overpressure condition, causing the reset pin 240 to move from its un-tripped position to its tripped position, and causing the control element 174 to move, along the slam-shut axis 185, toward and into contact with the slam-shut valve seat 124, thereby closing the flow orifice 140 and shutting off fluid flow through the flow path 136 in the valve body 120.

When the overpressure condition or the underpressure condition has been corrected, and shutoff is no longer needed, the slam-shut safety device 100 can be opened, as illustrated in FIG. 2. When the diaphragm 274 senses that the overpressure or the underpressure condition has been resolved, the diaphragm 274 moves, When the overpressure condition has been resolved, the diaphragm 274 moves to the right (in FIG. 6), which thus causes the control rod 278 to move (also to the right) as well. This moves the control rod 278 out of engagement and away from the base 310 of the releasing stem 290, which causes the releasing stem 290 to rotate (in a counterclockwise direction in FIG. 6) about the pivot axis 306. But when the underpressure condition has been resolved, the diaphragm 274 moves to the left (in FIG. 6), which thus causes the control rod 278 to move (also to the left) as well. This moves the control rod 278 toward the base 310 of the releasing stem 290 until the force applied by the hook element on the base 310 is reduced (if not eliminated), which causes the releasing stem 290 to rotate (in a counterclockwise direction in FIG. 6) about the pivot axis 306. In either case the releasing stem 290 is positioned to again releasably engage the first trigger 294 when the first trigger 294, the second trigger 298, and the cam 302 are manipulated (e.g., by an operator) back to the position shown in FIG. 2. Manipulation of the first trigger 294, the second trigger 298, and the cam 302 in this manner will also move the reset pin 240 back toward its un-tripped position, which will in turn move the control element 174 away from the slam-shut valve seat 124 along the slam-shut axis 185, shifting the control element 174 and the valve stem 176 from the second position back to the first position.

At the same time, regardless of whether the slam-shut safety device 100 is in its open or closed position, the seal assembly 200 reduces, if not totally prevents, particulates carried by the fluid flowing through the one or more flow ports 166 from contacting, much less accumulating on, the outer surface 190. This ensures that the control element 174 is freely movable between its open and closed position, and, in particularly, is freely movable to its closed position when safety shutoff is necessary.

Finally, while not illustrated herein, it will be appreciated that the slam-shut safety device 100 may be equipped with one or more filters that help to capture and remove particulates in the fluid flowing through the slam-shut safety device 100. As an example, a filter may be disposed in the valve body 120 between the fluid inlet 128 and the orifice 140. Further, while also not illustrated herein, it will be appreciated that the slam-shut safety device 100 may be equipped with a plurality of pressure measurement devices (e.g., manometers, Bourdon gauges) that are arranged to determine whether particulates have accumulated on the outer surface 190 of the control element 174. As an example, one pressure measurement device may be employed to measure the pressure at the top of the control element 174 and another pressure measurement device may be employed to measure the pressure at the bottom of the control element 174. The pressure data can be singly or continually processed (e.g., by a controller in the fluid distribution system) to determine whether accumulation has occurred (i.e., whether the control element 174 needs to be cleaned or replaced, or other maintenance is necessary).

Each of the optional arrangements described herein may be arranged in any set of combinations or permutations sufficient to provide any combination of one or more functionalities suggested by the description provided herein. Further, it is understood that each of the features disclosed with respect to each exemplary arrangement may be combined in any functional combination, such as to provide any useful combination of functionalities as would be understood by a person of ordinary skill.

While certain representative arrangements of slam-shut devices and details have been described herein for purposes of illustrating the invention, it will be apparent to those skilled in the art that various changes in the devices disclosed may be made without departing from the spirit and scope of the invention, which is defined by the following claims and is not limited in any manner by the foregoing description.

1. An assembly for a slam-shut safety device, the assembly comprising:
a valve body having an inlet, an outlet, and defining a flow path extending between the inlet and the outlet, the valve body including a slam-shut valve seat defining an orifice that forms part of the flow path between the inlet and the outlet;
a bonnet coupled to the valve body, the bonnet comprising a sleeve extending into the flow path, the sleeve comprising one or more flow ports;
a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice;
a reset pin operatively coupled to the control element and movable along the slam-shut axis relative to the valve body between an un-tripped position, placing the control element in the open first position, and a tripped position, placing the control element in the closed second position, the reset pin adapted to move from the un-tripped position toward the tripped position responsive to an overpressure condition or an underpressure condition; and
a seal arranged to direct fluid flowing through the one or more flow ports of the sleeve away from an outer surface of the control element, thereby substantially preventing accumulation of particulates carried by the fluid on the outer surface of the control element.

2. The assembly of claim 1, wherein the seal comprises at least one of an o-ring and a piston ring.

3. The assembly of claim 1, further comprising a valve stem, wherein the reset pin is operatively coupled to the control element via the valve stem.

4. The assembly of claim 1, further comprising a biasing element arranged to bias the control element toward the closed second position.

5. The assembly of claim 4, wherein the biasing element has a first end seated against the bonnet and a second end seated against the control element.

6. The assembly of claim 4, wherein the biasing element is at least partially disposed within the control element.

7. The assembly of claim 1, wherein the seal prevents fluid from flowing between the sleeve and the control element.

8. An assembly for a slam-shut safety device, the assembly comprising:
a valve body having an inlet, an outlet, and defining a flow path extending between the inlet and the outlet, the valve body including a slam-shut valve seat defining an orifice that forms part of the flow path between the inlet and the outlet;
a bonnet coupled to the valve body, the bonnet comprising a sleeve extending into the flow path, the sleeve comprising one or more flow ports;
a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice;
a reset pin operatively coupled to the control element and movable along the slam-shut axis relative to the valve body between an un-tripped position, placing the control element in the open first position, and a tripped position, placing the control element in the closed second position, the reset pin adapted to move from the un-tripped position toward the tripped position responsive to an overpressure condition or an underpressure condition; and
a seal assembly arranged in a gland formed in the sleeve or the control element to direct fluid flowing through the one or more flow ports of the sleeve away from an outer surface of the control element, thereby substantially preventing accumulation of particulates carried by the fluid on the outer surface of the control element.

9. The assembly of claim 8, wherein the gland is formed in an outer surface of the control element.

10. The assembly of claim 8, wherein the seal assembly comprises an o-ring and a piston ring.

11. The assembly of claim 8, further comprising a valve stem, wherein the reset pin is operatively coupled to the control element via the valve stem.

12. The assembly of claim 8, further comprising a biasing element arranged to bias the control element toward the closed second position.

13. The assembly of claim 12, wherein the biasing element has a first end seated against the bonnet and a second end seated against the control element.

14. A slam-shut safety device, comprising:
a valve body having an inlet, an outlet, and defining a flow path extending between the inlet and the outlet, the valve body including a slam-shut valve seat defining an orifice that forms part of the flow path between the inlet and the outlet;
a bonnet coupled to the valve body, the bonnet comprising a sleeve extending into the flow path, the sleeve comprising one or more flow ports;
an actuator coupled to the bonnet and arranged to detect an overpressure condition or an underpressure condition;
a control element movably disposed within the sleeve, the control element movable along a slam-shut axis between an open first position, in which the control element is spaced away from the slam-shut valve seat, thereby allowing fluid flow through the orifice, and a closed second position, in which the control element is seated against the slam-shut valve seat, thereby preventing fluid flow through the orifice;
a reset pin operatively coupled to the control element and movable along the slam-shut axis relative to the valve body between an un-tripped position, placing the control element in the open first position, and a tripped position, placing the control element in the closed second position, wherein the reset pin is configured to move from the un-tripped position toward the tripped position responsive to the actuator detecting the overpressure condition or the underpressure condition; and
a seal arranged to direct fluid flowing through the one or more flow ports of the sleeve away from an outer surface of the control element, thereby substantially preventing accumulation of particulates carried by the fluid on the outer surface of the control element.

15. The slam-shut safety device of claim 14, wherein the seal is arranged in a gland formed in the sleeve or the control element.

16. The slam-shut safety device of claim 14, wherein the seal comprises at least one of an o-ring and a piston ring.

17. The slam-shut safety device of claim 14, further comprising a biasing element arranged to bias the control element toward the closed second position.

18. The slam-shut safety device of claim 17, wherein the biasing element has a first end seated against the bonnet and a second end seated against the control element.

19. The slam-shut safety device of claim 14, wherein the actuator comprises a relay mechanism, wherein the relay mechanism has a first position in which the relay mechanism retains the reset pin in the un-tripped position, and wherein responsive to the actuator detecting the overpressure condition or the underpressure condition, the relay mechanism moves from the first position to a second position in which the relay mechanism allows the reset pin to move from the un-tripped position to the tripped position.

20. The slam-shut safety device of claim 19, wherein the actuator further comprises a diaphragm operatively coupled to the relay mechanism via a control rod, wherein the diaphragm moves responsive to the overpressure condition or the underpressure condition, and wherein movement of the diaphragm causes the relay mechanism to move from the first position to the second position.
